(19) United States
(12) Patent Application Publication
(10) Pub. No.: US 2022/0234770 A1
(43) Pub. Date: Jul. 28, 2022

(54) A METHOD FOR REALISING A BIODEGRADABLE PACKAGING OF A PRODUCT FOR PREPARATION OF BEVERAGES

(71) Applicant: LOVITALIA S.r.L., ROMA (IT)

(72) Inventor: Valerio TAGLIOLI, BOLOGNA (IT)

(21) Appl. No.: 17/605,351

(22) PCT Filed: Apr. 23, 2020
(86) PCT No.: PCT/IB2020/053842

§ 371 Date: Oct. 21, 2021

(30) Foreign Application Priority Data
Apr. 24, 2019 (IT) 102019000006294

(51) Int. Cl. B65B 29/02; B65D 85/804; B65B 1/02; B65B 7/16

(52) U.S. Cl. CPC B65B 29/025; B65D 85/8046; B65B 2220/16; B65B 7/164; B65B 1/02

(57) ABSTRACT

A method for realizing a biodegradable packaging of a product for preparation of beverages, includes providing a first reel of a first film of biodegradable material utilisable for formation of a pod for containing a product for preparation of beverages. The method further includes providing a second reel of a second film of biodegradable material utilisable for formation of a cladding of the pod and obtaining a biodegradable packaging of a product for preparation of beverages.

### FIELD OF THE INVENTION

The present invention relates to the technical sector concerning the packaging of products for the preparation of hot and/or cold beverages, such as for example coffee, tea, malted drinks, infusions, etc.

Products for the preparation of beverages are usually in a granular, powder, lyophilised or ground form, so they are usually predisposed internally of relative sealed packaging to safeguard the properties, taste and flavours thereof.

The sealed packagings are then inserted by the user into special automatic machines for dispensing the beverage.

Various types and packagings are known that are utilised for containing the products for the preparation of beverages.

A particular type of packaging comprises a pod, containing the product for preparation of the beverage, which is closed and sealed inside an external cladding.

The pod is made of a biodegradable material, such as for example polylactic acid (PLA), and comprises a hollow body, having a base, for example circular, and lateral walls, for example a cylindrical wall, internally of which the product for the preparation of the beverage is predisposed, and a closing cover applied and fixed to the body.

The pod, thus-formed, can then be compressed and compacted by the used of a sonotrode.

The cladding materials used for cladding the pod, and for the realising of the final packaging, are of the non-biodegradable type, such as for example a multilayer aluminium sheet.

### DESCRIPTION OF THE PRIOR ART

A known method for realising a packaging of products for preparation of beverages comprises, first, realising the pod using a biodegradable material, and then cladding the pod using a non-biodegradable material.

To realise the pod, a first sheet is unwound and cut from a first reel of a film of biodegradable material, such as for example PLA (polylactic acid) and then a second sheet is unwound and cut from a second reel of a film of biodegradable material, such as for example PLA (polylactic acid).

Cuts are made in the first sheet of biodegradable material in such a way as to obtain a series of first pieces of biodegradable material; for example the cuts are made in such a way as to obtain a series of first pieces having a circular shape.

The cuts are made in such a way that the first pieces of biodegradable material have a diameter that is such that, for each thereof, by folding an external circular portion with respect to an internal circular portion, a hollow body can be obtained that has a base wall and a lateral cylindrical wall.

Cuts are made in the second sheet of biodegradable material in such a way as to obtain a series of second pieces of biodegradable material having a circular shape having a sufficient diameter for being applied to close the hollow bodies obtained following the folding of the first pieces.

Once the first pieces of biodegradable material have been folded to form the hollow bodies, a step of filling the hollow bodies is carried out with the products for the preparation of beverages, and then a step of application of the second pieces of biodegradable material to close the hollow bodies, and lastly a step of fixing, for example by heat-welding, the second pieces to the hollow bodies.

In this way pods are obtained that contain internally thereof a product for preparation of a beverage.

A final step is possible in which the pods are compacted using a sonotrode.

In this way, the porosity can be eliminated and the product for the preparation of the beverage compressed and thus compacted.

At the same time, or following the above-described steps, a first sheet of cladding is unwound and cut from a first reel of a film of non-biodegradable material (such as for example an aluminium multi-layer material) and a second sheet of cladding is in turn unwound and cut from a second reel of a film of non-biodegradable material (such as for example an aluminium multi-layer material).

The two sheets of non-biodegradable material are used to realise the cladding of pod in the following way.

A first sheet of cladding is positioned above the centring organs, which define predetermined positions in which the pods must be positioned above the first sheet of cladding.

The pods are positioned above the first sheet of cladding, at the predetermined positions defined by the centring organs, and then the second sheet of cladding is positioned above the pods.

A plurality of heat-forming and heat-welding operations are then carried out on each of the pods interposed between the two sheets of cladding material.

In particular, the heat-welding is carried out in such a way that the parts of the two sheets of cladding that are located above and below the pods are heat-welded to one another to form a heat-welded portion that surrounds the pods.

The two sheets are then subjected to cutting operations in such a way as to carry out circular cuts externally of the heat-welded circular portions, thus obtaining the final circular-shaped packagings which enclose internally thereof the pods containing the products for the preparation of a beverage.

The above-described steps for realising the packagings of the products for the preparation of beverages do not create any particular issues, in particular the carrying out of the steps of heat-forming, heat-welding and cuts of the two cladding sheets in non-biodegradable material, as they are sufficiently rigid not to be subject to deformations during the operations of heat-welding and cutting.

The final packagings obtained therefore have a substantially uniform shape, with the pod perfectly centred, with the outlines well-defined and therefore appealing from the aesthetic point of view.

In recent times, for various reasons, primarily to guarantee an ecological elimination of the packagings once they have been used for the preparation of beverages, the need to have packagings of products for the preparation of beverages that are entirely biodegradable has become increasingly pressing, i.e. in reference to those packagings where not only the pod but also the cladding of the pod are made of biodegradable material.

A type of biodegradable material that can be used as a cladding for the pods is constituted by Ecoralene, i.e. a coupled film based on biodegradable material and compostable materials (such as for example materials based on cellulose or biopolymer of vegetable origin).

However problems have emerged related to the above-described steps of heat-welding and cutting when using sheets of Ecoralene for realising the cladding of the pods.

In fact, the tensions that are created on the sheets of Ecoralene, during the heat-welding step can cause a relative displacement between the portions of the two sheets, which must be reciprocally heat-welded, and the pods interposed between them, and thus can lead to obtaining non-optimal final packagings, as the pods will not be perfectly centred.

Further, the tension to which the sheets of Ecoralene are subjected, following the application of heat, can lead to creasing and streaking, with a consequent impact on the aesthetic appeal of the final packagings.

### SUMMARY OF THE INVENTION

The aim of the present invention is therefore to provide a new method for realising a biodegradable packaging of products for preparation of beverages, able to obviate the drawbacks of the prior art described in the foregoing.

In particular, an aim of the invention is to provide a novel method enabling realising packaging for products for the preparation of beverages which, following use, are entirely biodegradable, concerning both the pod and the relative cladding, and which at the same time provide an optimal shape from both the structural and the aesthetic point of view.

A further aim of the present invention is to provide a novel biodegradable packaging of products for the preparation of beverages.

The above aims are attained in accordance with the contents of the claims.

### BRIEF DESCRIPTION OF THE DRAWINGS

The characteristics of a preferred embodiment of the method for realising a biodegradable packaging of products for preparation of beverages, as well as a preferred embodiment of the biodegradable packaging of products for the preparation of beverages, proposed by the present invention, will be described in the following with reference to the appended tables of drawings, in which:

FIG. 1 is a schematic illustration, in a perspective view, of a preferred succession of operating steps for realising a pod containing a product for preparation of a beverage according to the method of the invention;

FIG. 2 is a larger-scale view of the detail denoted by the letter K of FIG. 1;

FIG. 3 illustrates, in frontal views in vertical section, a sequence of special operating steps of the realising of the pod according to the method of the invention;

FIG. 4 illustrates, in frontal views, some in vertical section, a further sequence of special operating steps of the realising of the pod according to the method of the invention;

FIG. 5 illustrates, in plan views from above, the steps of FIG. 4;

FIG. 6 is a schematic illustration, and in perspective view, of a pod containing a product for preparation of a beverage according to the method of the invention;

FIG. 7 illustrates, according to a schematic perspective view, further special steps of the method of the invention for realising the cladding of the pod and the obtaining of the final packaging;

FIG. 8 is a larger-scale view of the detail denoted by the letter H of FIG. 7;

FIGS. 9A, 9B and 9C illustrates, in relative frontal views in vertical section, a sequence of special operating steps of the realising of the cladding of the pod according to the method of the invention;

FIGS. 10A, 10B, 10C, 10C′, 10D, 10D′, illustrate, according to respective plan or frontal views in vertical section, further operating steps for completion of the final packaging according to the method of the invention;

FIG. 11A is a perspective view of the final biodegradable packaging of products for preparation of a beverage obtainable by means of the method of the invention, while FIG. 11B is a frontal view in vertical section of the packaging;

FIG. 12A illustrates possible variants relative to the realisation of the pod, while FIG. 12B illustrates corresponding variants relative to the realising of the cladding of the pod for obtaining the final packaging.

### DESCRIPTION OF PREFERRED EMBODIMENTS

The method for realising a biodegradable packaging of a product for preparation of beverages of the present invention comprises providing a first reel (1) of a first film (10) of biodegradable material, for example constituted by polylactic acid PLA, which is used for formation of a pod for containing a product for preparation of beverages, and providing a second reel (2) of a second film (20) of biodegradable material, for example constituted by Ecoralene, which is used for formation of a cladding of the pod.

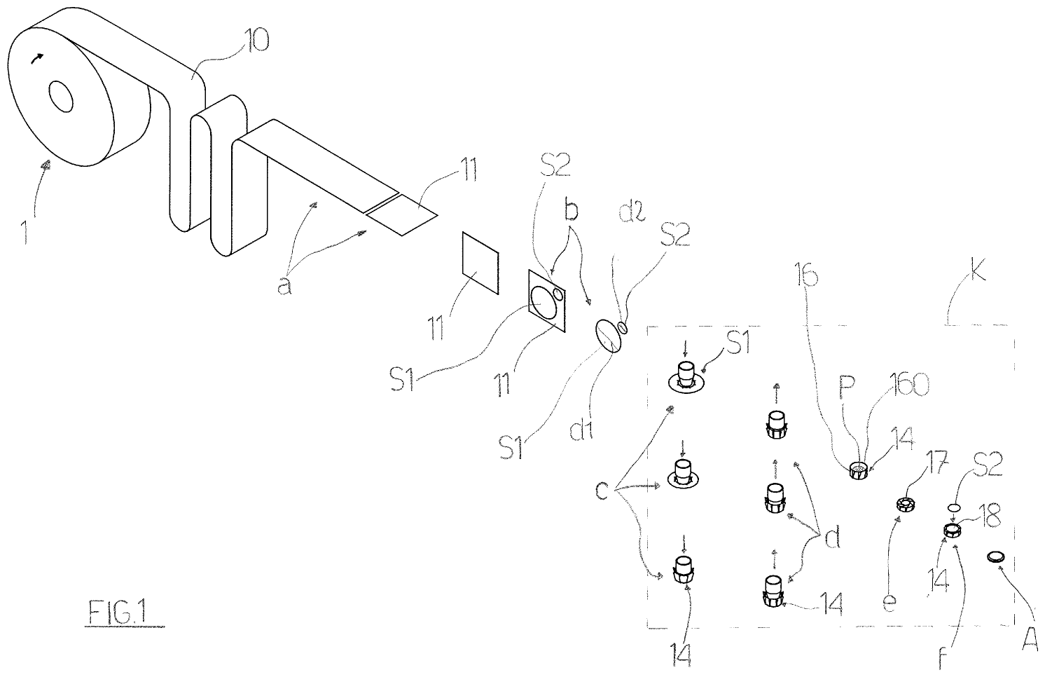

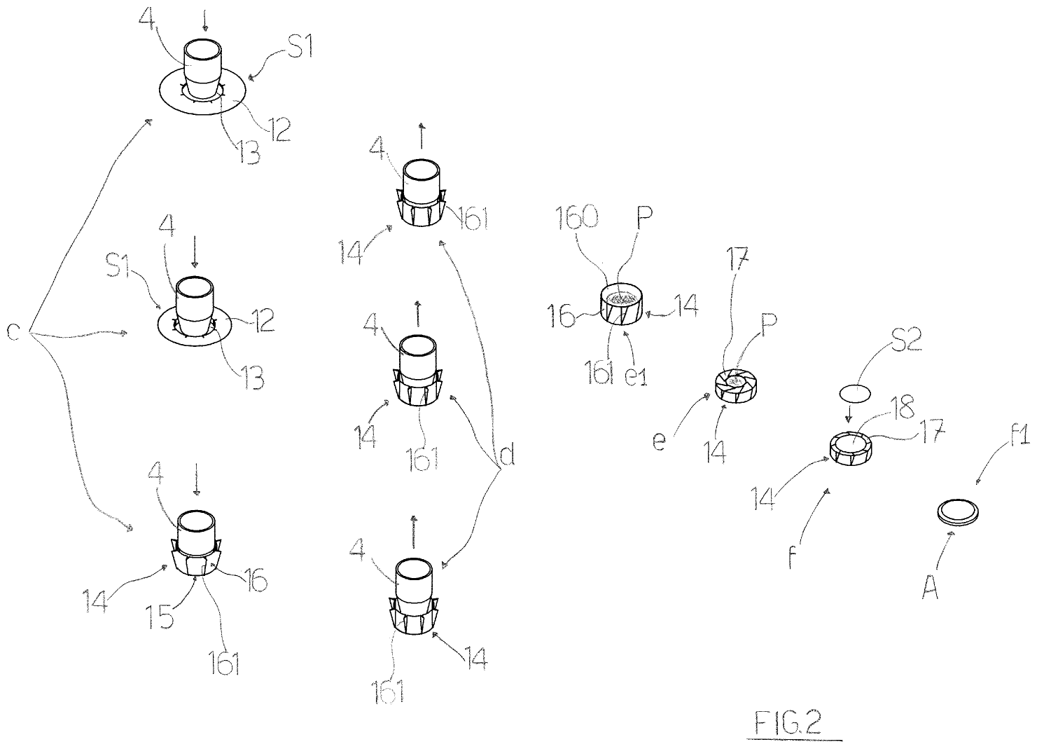

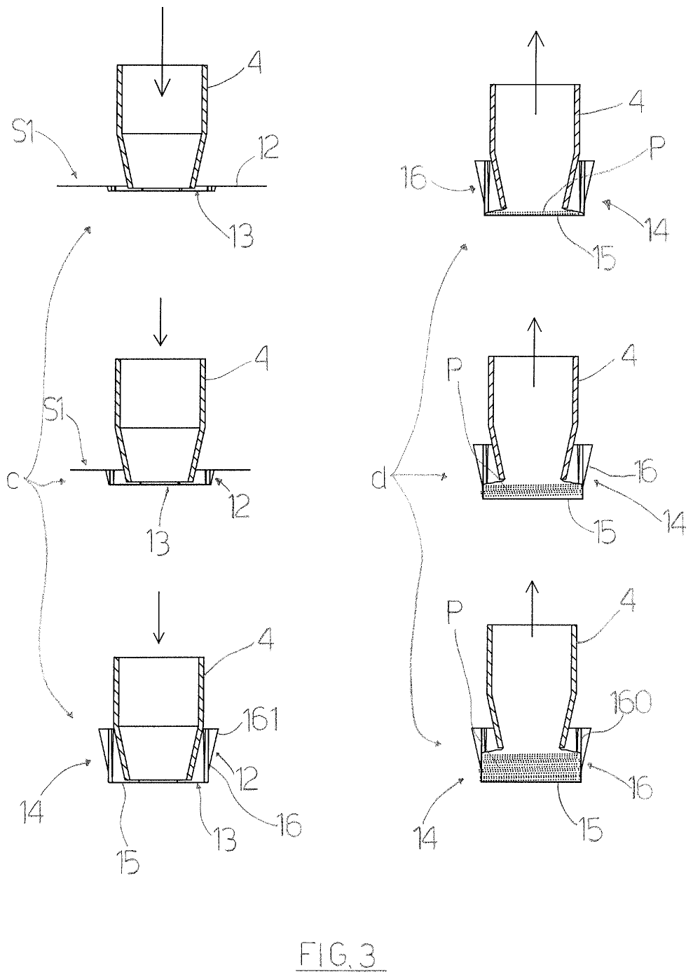

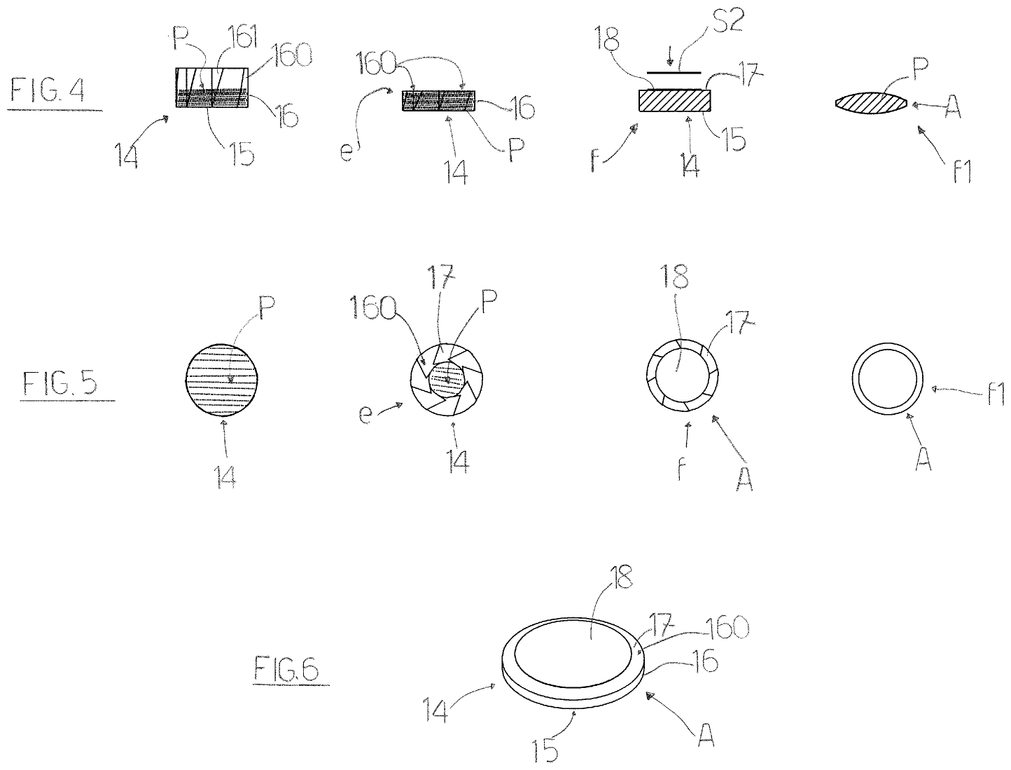

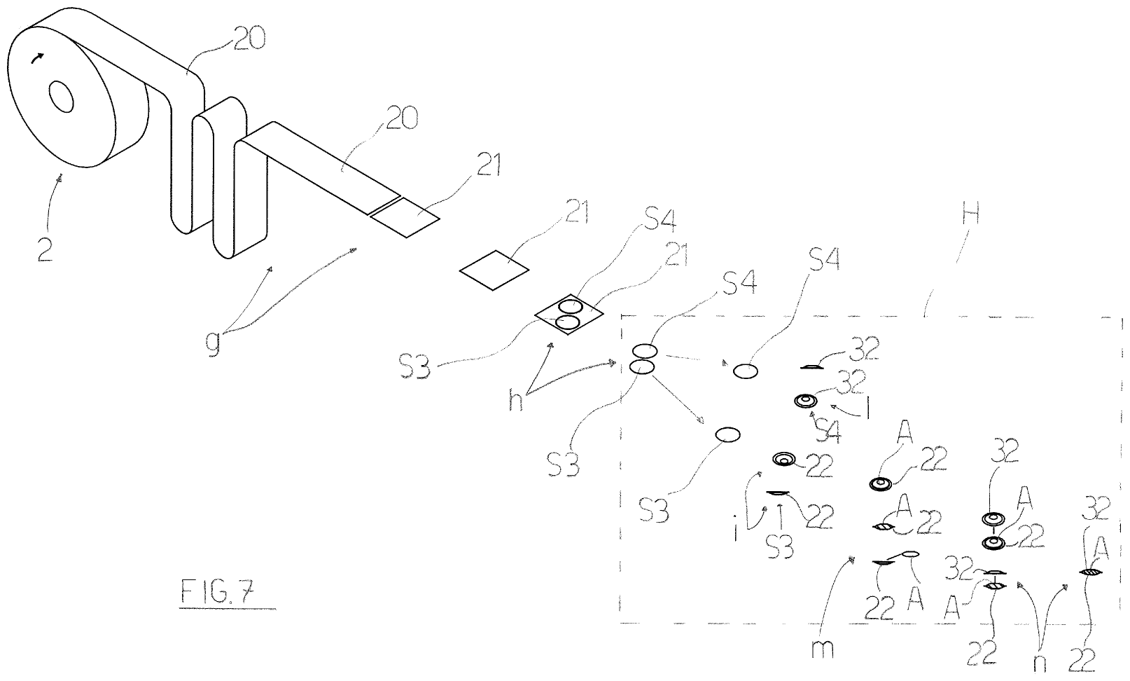

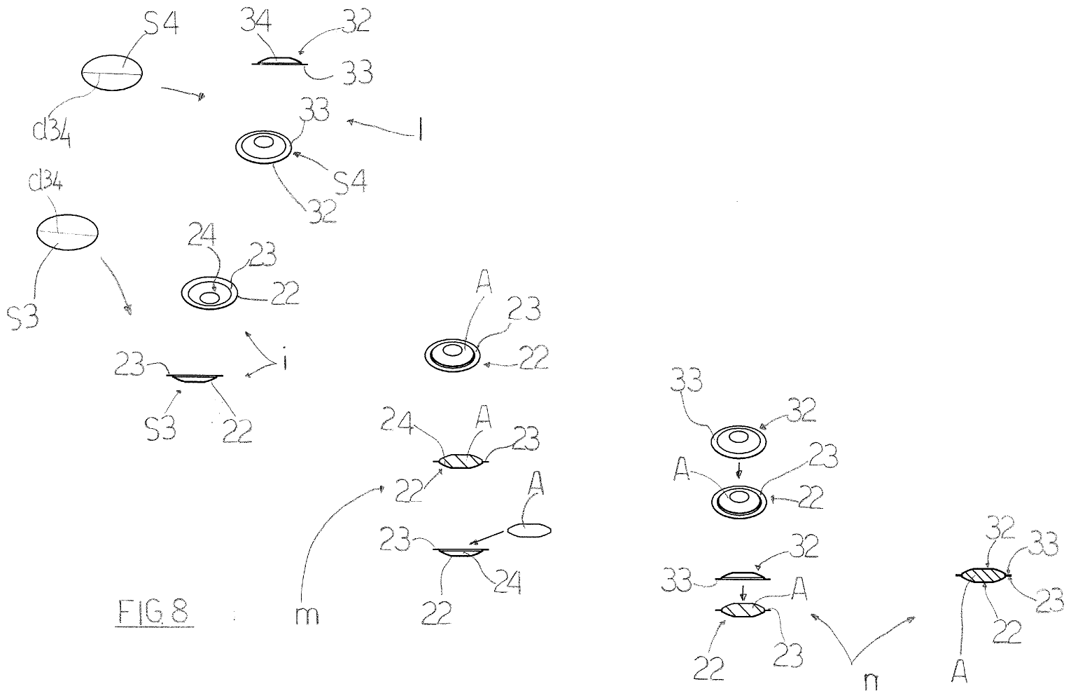

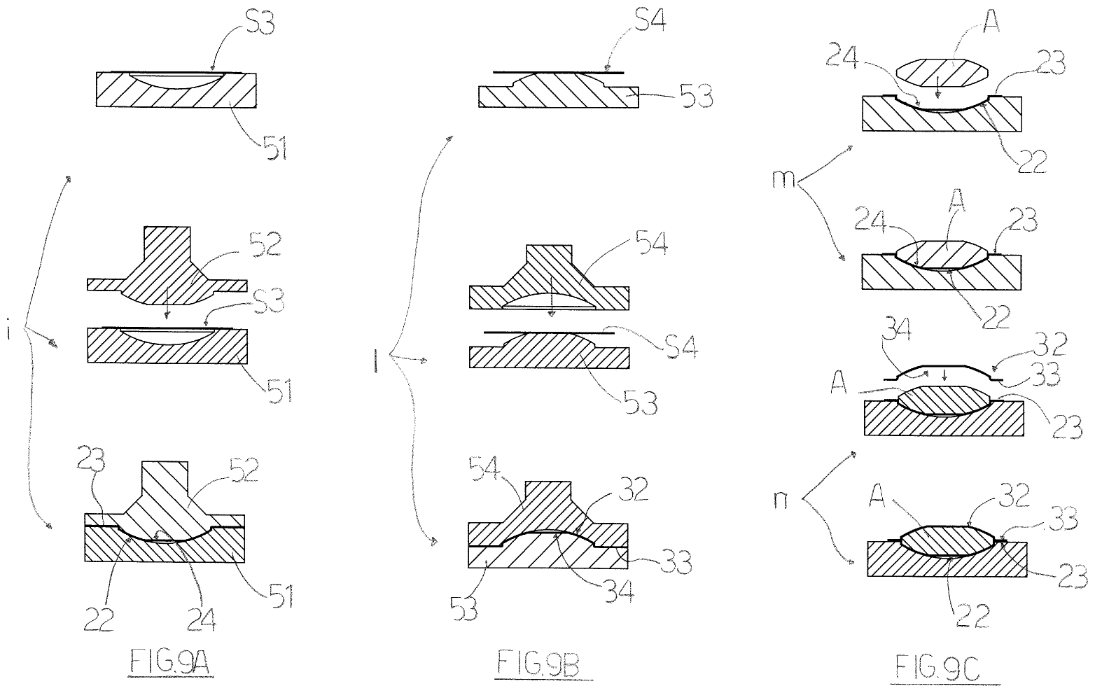

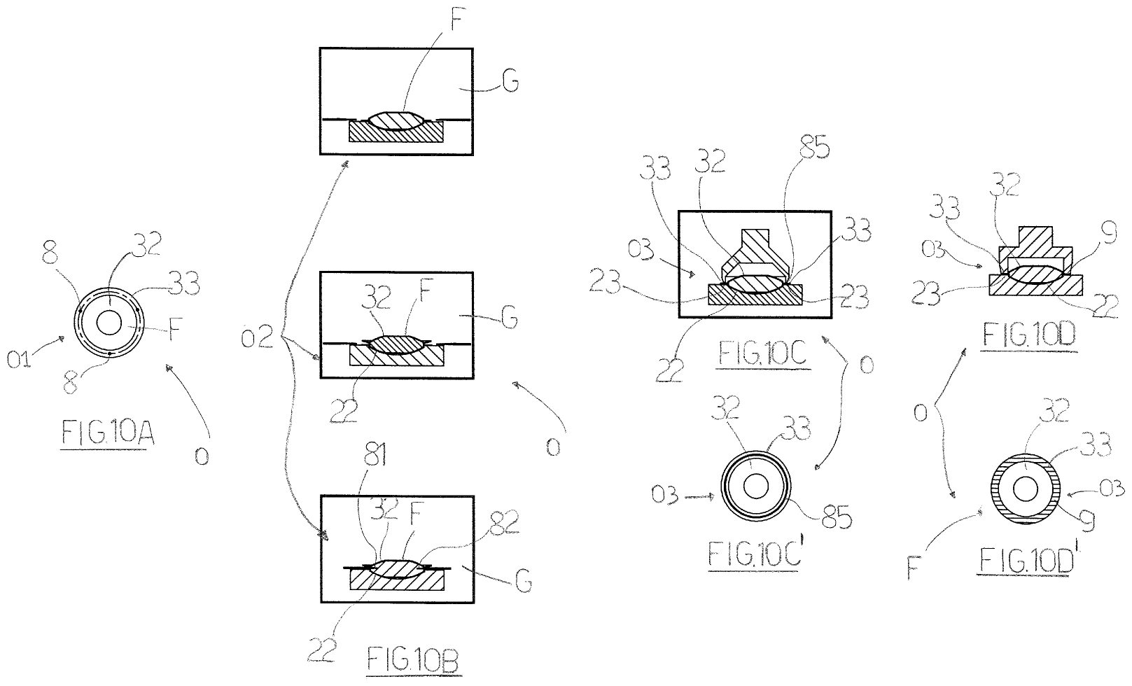

The method of the invention comprises carrying out the following special steps:
a step (a) of unwinding and cutting the first film (10) of biodegradable material from the first reel (1) wherein the first film (10) of biodegradable material is unwound from the first reel (1) and is cut in such a way as to obtain a first sheet (11) (see FIG. 1);
a step (b) of cutting the first sheet (11) in which the first sheet (11) is cut in such a way as to obtain at least a first circular piece (S1) and at least a second circular piece (S2), wherein the at least a first circular piece (S1) has a greater diameter than the at least a second circular piece (S2) and has dimensions that are such as to enable folding thereof in order to be able to form a hollow body having a circular base and a lateral wall (see FIG. 1);
a step (c) of folding the first circular piece (S1) wherein an external circular portion (12) of the first circular piece (S1) is folded with respect to an internal circular portion (13) so as to form a hollow body (14) having a circular base (15), defined by the internal circular portion (13), and a lateral wall (16) defined by the external circular portion (12) once folded with respect to the internal circular portion (13) (see FIGS. 1, 2 and 3);
a step (d) of filling in which a product (P) for preparation of a beverage is inserted and dosed in the hollow body (14) so as to fill a part of the volume of the hollow body (14) in such a way that an upper portion (160) of the lateral wall (16) of the hollow body (14) is free and not involved with the product (P) (see FIGS. 1, 2 and 3);
a step (e) of folding the upper portion (160) of the lateral wall (16) of the hollow body (14) wherein the upper portion (160) of the lateral wall (16) is folded by pleating so as to form a pleated crown (17) above the product (P) contained in the hollow body (14) (see FIGS. 1, 2, 4 and 5);
a step (f) of applying and fixing the second circular piece (S2) above the pleated crown (17) wherein the second circular piece (S2) is applied above the pleated crown (17) and fixed to the pleated crown (17) to form a closing cover (18) and close the hollow body (14) in such a way as to obtain a pod (A) containing the product (P) for preparation of a beverage (see FIGS. 1, 2, 4, 5 and 6).

In this way, with the carrying out of the above steps it is possible to use, differently to the prior art in which two different reels are used, a single reel (1) of a film of biodegradable material (10), such as for example polylactic acid (PLA), to obtain a pod (A) containing a product (P) for preparation of a beverage.

The product (P) can be a preparation in granular, power, lyophilised or ground form, which enables preparation of beverages such as for example coffee, tea, infusions and so on.

Further, owing to the special method with which the first circular piece is folded, in particular the folding by pleating of the upper portions of the lateral walls of the hollow body, it is possible to obtain a pleated crown above the product contained in the hollow body.

The pleated crown advantageously constitutes an optimal area for the positioning of the second circular piece which, once fixed to the pleated crown, will constitute the closing cover of the pod.

In this way, the fixing operations are facilitated, obtaining an optimal closure and sealing of the hollow body.

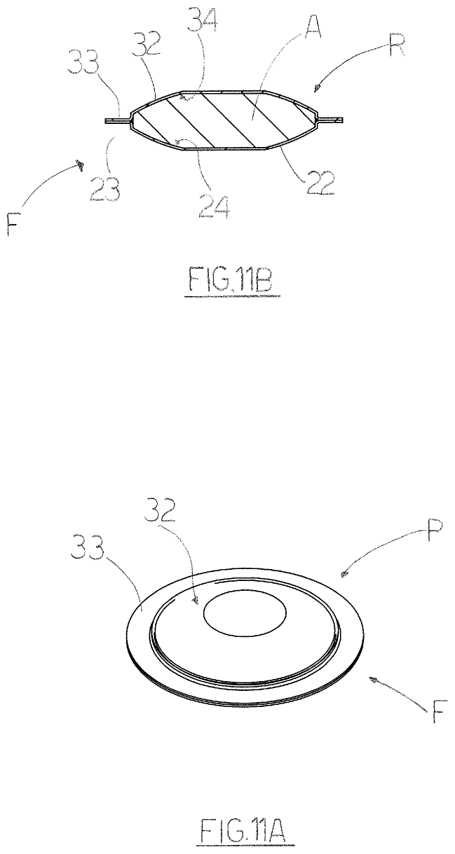

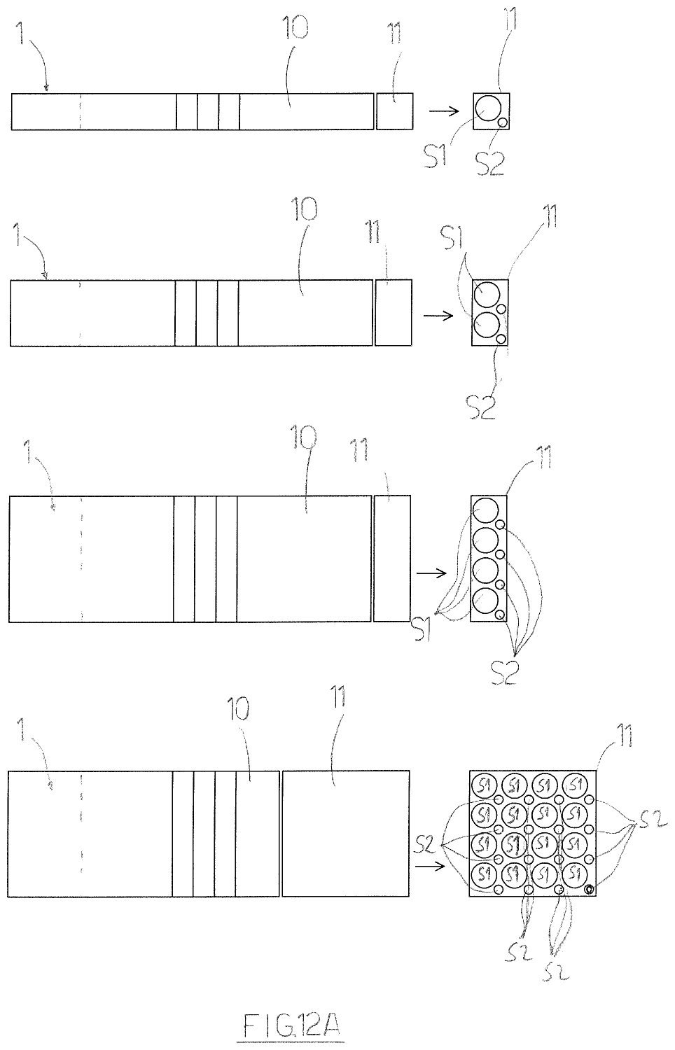

The method of the invention also comprises carrying out the following special steps, for realising the cladding of the pod and obtaining a final packaging:
a step (g) of unwinding and cutting the second film (20) of biodegradable material from the second reel (2) wherein the second film (20) of biodegradable material is unwound from the second reel (2) and is cut in such a way as to obtain a second sheet (21) (see FIG. 7);
a step (h) of cutting the second sheet (21) wherein the second sheet (21) is cut in such a way as to obtain at least a third circular piece (S3) and at least a fourth circular piece (S4), wherein the at least a third circular piece (S3) and the at least a fourth circular piece (S4) have a diameter substantially identical to and of greater dimensions than the diameter of the pod (A) (see FIG. 7);
a step (i) of heat-forming the third circular piece (S3) wherein the third circular piece is heat-formed so as to form a first valve-shaped element (22) having an annular peripheral portion (23) and a first seat (24) such as to be able to accommodate a lower part ofthe pod (A) (see FIGS. 7, 8, and 9A);
a step (1) of heat-forming of the fourth circular piece (S4) wherein the fourth circular piece (S4) is heat-formed so as to form a second valve-shaped element (32) having an annular peripheral portion (33) and a second seat (34) such as to be able to accommodate an upper part of the pod (A) (see FIGS. 7, 8, and 9B);
a step (m) of inserting and positioning the pod (A) in the first seat (24) of the first valve-shaped element (22) so that a lower part of the pod (A) is accommodated in the first seat (24) (see FIGS. 7, 8, and the upper part of 9C);
a step (n) of positioning the second valve-shaped element (32) above the first valve-shaped element (22) so that an upper part of the pod (A) is accommodated in the second seat (34) of the second valve-shaped element (32) and so that the annular peripheral portion (33) of the second valve-shaped element (32) superposes on the annular peripheral portion (23) of the first valve-shaped element (22) (see FIGS. 7, 8, and the lower part of 9C);
a step (o) of fixing and sealing the first valve-shaped element (22) to the second valve-shaped element (32) wherein the first valve-shaped element (22) and the second valve-shaped element (32) are fixed to one another and sealed to one another at the relative annular peripheral portions (23, 33) superposed on one another in such a way as to seal the pod (A) internally thereof and obtain a sealed biodegradable packaging (F) of a product (P) for preparation of a beverage (see FIGS. 10A, 10B, 10C, 10C′, 10D, 10D′).

Also for the realisation of the cladding of the pod, the method includes using a single reel of a film of biodegradable material, such as, for example, in particular Ecoralene, while in the prior art two distinct reels are used for the cladding film.

Further, the method according to the invention includes cutting, from a same sheet of biodegradable material of cladding, a third piece and a fourth piece which will constitute the two parts (the two valve-shaped elements) for forming the cladding.

The method of the invention advantageously includes heat-forming the third piece and the fourth piece, and obtaining the first valve-shaped element and the second valve-shaped element, prior to the superposing thereof on the pod.

In particular, the method includes forming two valve-shaped elements, each of which has a seat, having suitable dimensions for accommodating and containing a part of the pod, and an annular portion which surrounds the annular seat.

The step of forming the two seats in the two valve-shaped elements takes place separately and before the coupling of the two parts of cladding with the pod: in this way it is possible to precisely define, with no repercussions on the final packaging, the shape of the two parts which, once coupled, will define the final cladding of the pod, and thus the shape of the final packaging.

Further, the method advantageously includes realising the two valve-shaped elements in such a way that each thereof has an annular peripheral portion that surrounds the positioning seat of the pod.

In this way two areas are made, very precise and defined for reciprocally superposing the two valve-shaped elements at which the fixing and sealing can take place, with no repercussion on the pod contained in the two seats nor on the shape of the two valve-shaped elements.

Thus, the final packaging that is obtained with the method of the invention is realised entirely of biodegradable material, both for the material of the pod and the material of the cladding, and will have a well-defined shape in relation to the edge, perfectly circular, and the two containing caps of the pod formed by the two valve-shaped elements.

The steps (a) (of unwinding and cutting the first film (10) of biodegradable material from the first reel (1)), (b) (of cutting the first sheet (11) in which the first sheet (11) is cut in such a way as to obtain at least a first circular piece (S1) and at least a second circular piece (S2)), (c) (of folding the first circular piece (S1)), (d) (of filling), (e) (of folding the upper portion (160) of the lateral wall (16) of the hollow body (14)), (f) (of applying and fixing the second circular piece (S2) above the pleated crown (17)), can be carried out before, or at the same time, to the steps (g) (of unwinding and cutting the second film (20) of biodegradable material from the second reel (2)), (h) (of cutting the second sheet (21) in which the second sheet (21) is cut in such a way as to obtain at least a third circular piece (S3) and at least a fourth circular piece (S4)), (i) (of heat-forming the third circular piece (S3)) and (1) (of heat-forming the fourth circular piece (S4)).

Further advantageous aspects of the method of the invention are described in the following.

In a preferred aspect, the step (c) of folding the first circular piece (S1) takes place by carrying out a drawing of the first circular piece (S1) by means of a punch shaped dosing element (4) (see in particular the left part of FIG. 3), wherein the punch shaped dosing element (4) pushes the first circular piece (S1) through a circular through-hole so that the external circular portion (12) of the first circular piece (S1) external of the circular through-hole is folded with respect to an internal circular portion (13) of the first circular piece (S1) thus forming a hollow body (14) having a circular base (15), defined by the internal circular portion (13), and a lateral wall (16) defined by the external circular portion (12) once folded with respect to the internal circular portion (13).

Further, step (d) of filling the hollow body (14) with the product (P) for preparation of a beverage is carried out during the lifting of the punch shaped dosing element (4) from the hollow body (14) (see in particular the right part of FIG. 3), the punch shaped dosing element (4) releasing and dosing the product (P) for preparation of a beverage internally of the hollow body (14) while being lifted and extracted from the hollow body (14).

In a further aspect, during the step (c) of folding the first circular piece (S1) to form the hollow body (14), on the external circular portion (12) of the first circular piece (S1), folded with respect to the internal circular portion (13), for forming the lateral wall (16) of the hollow body (14), outwardly-projecting fins (161) are formed.

In this case, the method includes, before the step (e) of folding the upper portion (160) of the lateral wall (16) of the hollow body (14) which is folded by means of pleating to form a pleated crown (17) above the product (P) contained in the hollow body (14), a step (e1) of laterally folding the projecting fins (161) is carried out so as to fold the fins (161) against the lateral wall (16) of the hollow body (14).

Following the step (f) of applying and fixing the second circular piece (S2) above the pleated crown (17) to form a closing cover (18) and close the hollow body (14) and to obtain a pod (A) containing the product (P) for preparation of a beverage, the method includes carrying out a step (f1) of compacting the pod (A) and the product (P) contained therein with elimination of air porosity by means of use of a sonotrode so as to obtain a compact pod (A) containing the product (P) for preparation of a beverage, the product being compacted and without air porosity.

In particular, during the step (f) of applying and fixing the second circular piece (S2) above the pleated crown (17), the method includes carrying out a fixing of the second circular piece (S2) to the pleated crown (17) by means of welding.

In a second preferred way, the step (i) of heat-forming the third circular piece (S3) comprises heat-forming the third circular piece (S3), by positioning it in a female heat-forming matrix (51) and performing the heat-forming using a male heat-forming counter-matrix (52) to push the third circular piece (S3) into the female heat-forming matrix (51) and form the first valve-shaped element (22) with the first seat (24) in order to accommodate the lower part of the pod (A) (see the sequence of FIG. 9A).

Correspondingly, the step (1) of heat-forming the fourth circular piece (S4) comprises heat-forming the fourth circular piece (S4) by positioning it at a male heat-forming matrix (53) and performing heat-forming using a female heat-forming counter-matrix (54) so as to push the fourth circular piece (S4) about the male heat-forming matrix (53) and form the second valve-shaped element (32) with the second seat (34) in order to accommodate the upper part of the pod (A) (see the sequence of FIG. 9B).

With the purpose of obtaining an optimal seal of the final packaging, the method of the invention advantageously includes that the step (o) of fixing and sealing the first valve-shaped element (22) with the second valve-shaped element (32) so as to seal the pod (A) and obtain the packaging (F) comprises:

a step (o1) of performing pre-welding spots (8) between the annular peripheral portion (23) of the first valve-shaped element (22) and the annular peripheral portion (33) of the second valve-shaped element (32), superposed on one another (see FIG. 10A);

a step (o2) of aspirating the residual oxygen internally of the packaging (F) and injecting an inert gas into the packaging (F) inserting relative aspirating needles (81) and injecting needles (82) between the first valve-shaped element (22) and the second valve-shaped element (32) in the spaces present between the pre-welding spots (8) (see the sequence of FIG. 10B);

a step (o3) of final welding which comprises carrying out a ring welding (85) between the annular peripheral portion (23) of the first valve-shaped element (22) and the annular peripheral portion (33) of the second valve-shaped element (32), superposed on one another, in order to seal the packaging (F) (see for example FIGS. 9C and 9C′).

The step (o2) of aspirating the oxygen and injecting the inert gas is carried out by inserting the packaging (F) in a controlled-atmosphere environment (G).

For example, once the packaging (F) is inserted, in which the pre-welding spots (8) have been applied, inside the controlled-atmosphere environment (G), the parts of the annular peripheral portions of the two valve-shaped elements which are between the pre-welding spots (8) are partly lifted, in such a way as to define the spaces for insertion of the aspirating needles (81) of the oxygen and the injecting needles (82) of the inert gas (for example nitrogen).

Once the aspirating and injecting operations, the needles are retracted and the lifted parts newly repositioned with respect to one another in reciprocal contact so as to enable the carrying out of the step (o3) of final welding.

The final welding step (o3) preferably comprises further carrying out a supplementary welding (9), by completely welding together the annular peripheral portion (23) of the first valve-shaped element (22) and the annular peripheral portion (33) of the second valve-shaped element (32), superposed on one another (see for example FIGS. 10D and 10D′).

The method of the invention comprises a step (b) of cutting the first sheet (11) of biodegradable material for obtaining at least the first circular piece (S1) and at least the second circular piece (S2) utilisable for realising the pod (A) is carried out in such a way as to cut at least a first circular piece (S1) having a diameter (d1) comprised between 80 mm and 90 mm, and preferably 84 mm, and in such a way as to cut at least a second circular piece (S2) having a diameter (d2) comprised between 25 mm and 35 mm, and preferably 30 mm.

Further, in a preferred way, for these dimensions of the first piece and the second piece, the method includes the step (h) of cutting the second sheet (21) of biodegradable material so as to obtain at least a third circular piece (S3) and at least a fourth circular piece (S4) utilisable for cladding the pod (A) and for realising the packaging (F), is carried out in such a way as to cut at least a third circular piece (S3) and at least a fourth circular piece (S4) having a diameter (d34) comprised between 50 mm and 60 mm, and preferably 54 mm.

FIGS. 12A and 12B illustrate examples of various possible modes of carrying out the method of the invention as a function of the productivity which it is desired to reach.

For example, with the method of the invention, by using a first reel (1) of a first film (10) of biodegradable material, such as polylactic acid, for realising the pod, 120 mm wide, it is possible to cut the film and obtain a first sheet (11) having a square shape and a side 120 mm long.

The first sheet (11) is then cut to obtain a first circular piece (S1) having a diameter of 84 mm and a second circular piece (S2) having a diameter of 30 mm.

In this case, a second reel (2) of a second film (20) of biodegradable material, such as Ecoralene, is used, for realising the cladding with a 110 mm width, and a second sheet (12) having a rectangular shape with sides of 110 mm and 120 mm from which the third circular piece (S3) is cut and the fourth circular piece (S4), each having a diameter of 54 mm.

For this, see the first figures at the top in FIGS. 12A and 12B.

With these dimensions up to 50 packagings a minute can be made.

By increasing the width of the two films of biodegradable material, and/or the dimensions of the two sheets which are cut therefrom, it is possible to significantly increase the productivity.

For example, by using a first film (10) of biodegradable material (polylactic acid), 220 mm wide, it is possible to cut a first sheet (11) having a rectangular shape with sides of 120 mm and 220 mm from which two first pieces (S1) can be made, each having a diameter of 84 mm, and two second pieces (S2) each having a diameter of 30 mm (see the second figure from the top of FIG. 12A).

In this case, a second film (20) of biodegradable material (Ecoralene), will be used, having a width of 190 mm and a second sheet (21) having a rectangular shape with sides of 120 mm and 190 mm will be cut.

From the second sheet (21) it is possible to fashion two third pieces (S3) and two fourth pieces (S4), both having a diameter of 54 mm (see the second figure from the top of FIG. 12B).

With these dimensions up to 100 packagings per minute can be made.

For example, by using a first film (10) of biodegradable material (polylactic acid), 420 mm wide, it is possible to cut a first sheet (11) having a rectangular shape with sides of 120 mm and 420 mm from which four first pieces (S1) can be made, each having a diameter of 84 mm, and four second pieces (S2), each having a diameter of 30 mm (see the third figure from the top of FIG. 12A).

In this case, a second film (20) of biodegradable material (Ecoralene), will be used, having a width of 350 mm and a second sheet (21) having a rectangular shape with sides of 350 mm and 120 mm will be cut therefrom.

From the second sheet (21) it is possible to fashion four third pieces (S3) and two fourth pieces (S4), each having a diameter of 54 mm (see the third figure from the top of FIG. 12B).

With these dimensions up to 200 packagings per minute can be made.

Lastly, for example, by using a first film (10) of biodegradable material (polylactic acid), 420 mm wide, it is possible to cut a first sheet (11) having a square shape with sides of 420 mm and 420 mm from which sixteen first pieces (S1) can be made, each having a diameter of 84 mm, and 16 second pieces (S2), each having a diameter of 30 mm (see the figure at the bottom of FIG. 12A).

In this case, a second film (20) of biodegradable material (Ecoralene), will be used, having a width of 350 mm and a second sheet (21) will be cut therefrom having a rectangular shape with sides of 350 mm and 420 mm.

From the second sheet (21) it is possible to fashion sixteen third pieces (S3) and 16 fourth pieces (S4), each having a diameter of 54 mm (see the figure at the bottom of FIG. 12B).

With these dimensions up to 800 packagings per minute can be made.

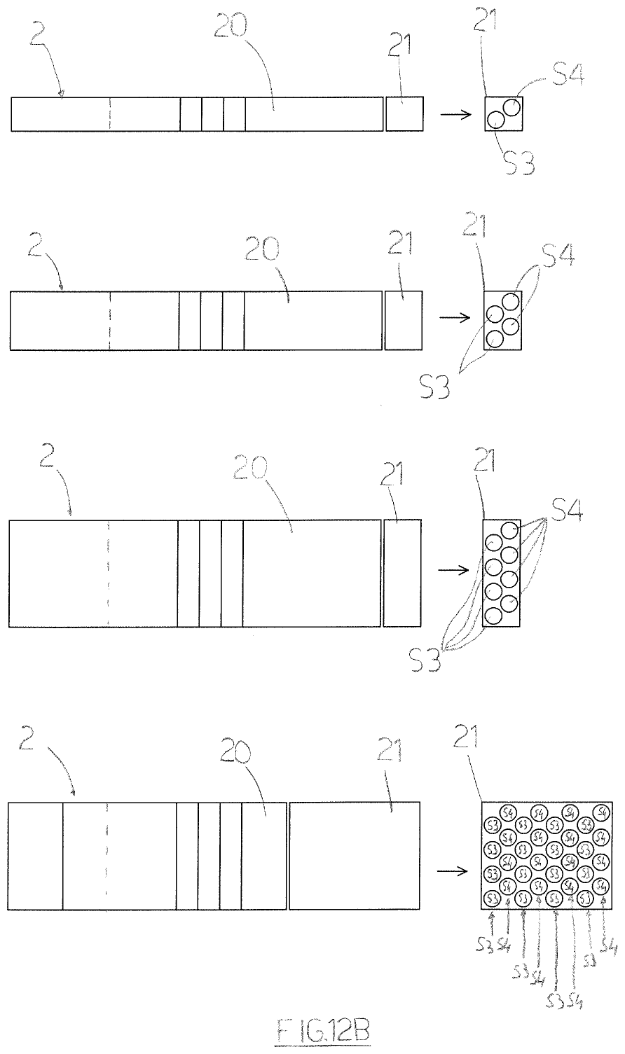

FIGS. 11A and 11B illustrate the biodegradable packaging (F) of a product for preparation of a beverage, obtainable by means of the above-described method.

The biodegradable packaging comprises:

a pod (A) made of a biodegradable material, containing a product (P) for preparation of a beverage, and a cladding (R) made of a biodegradable material which envelops and seals the pod (A).

In particular:

the pod (A) comprises a hollow body (14), containing the product (P) for preparation of a beverage, and having a base wall (15) and a lateral wall (16) the upper portions (160) of which are folded by means of pleating above the product (P) to form a pleated crown (17), and a closing cover (18) above the pleated crown (17) and fixed to the pleated crown (17);

the cladding (R) comprises a first valve-shaped element (22) having an annular peripheral portion (23) and a first seat (24) which receives a lower part of the pod (A) and a second valve-shaped element (32) having an annular peripheral portion (33) and a second seat (34) which receives an upper part of the pod (A), the first valve-shaped element (22) and the second valve-shaped element (32) being coupled to one another and sealed to one another at the relative annular peripheral portions (23,33).

The pod (A) preferably has a compacted shape without air porosity following a treatment utilising a sonotrode.

The pod (A) is made of a biodegradable material constituted by polylactic acid and wherein the first valve-shaped element (22) and the second valve-shaped element (32) which form the cladding (R) are made of a biodegradable material constituted by Ecoralene.

1. A method for realising a biodegradable packaging of a product for preparation of beverages, comprising:
providing a first reel of a first film of biodegradable material utilisable for formation of a pod for containing a product for preparation of beverages,
providing a second reel of a second film of biodegradable material utilisable for formation of a cladding of the pod, and carrying out;
a step (a) of unwinding and cutting the first film of biodegradable material from the first reel wherein the first film of biodegradable material is unwound from the first reel and is cut in such a way as to obtain a first sheet;
a step (b) of cutting the first sheet in which the first sheet is cut in such a way as to obtain at least a first circular piece and at least a second circular piece, wherein the at least a first circular piece has a greater diameter than the at least a second circular piece and has dimensions that are such as to enable folding thereof in order to be able to
form a hollow body having a circular base and a lateral wall;
a step (c) of folding the first circular piece wherein an external circular portion of the first circular piece is folded with respect to an internal circular portion so as to form a hollow body having a circular base, defined by the internal circular portion, and a lateral wall defined by the external circular portion once folded with respect to the internal circular portion;
a step (d) of filling in which a product for preparation of a beverage is inserted and dosed in the hollow body so as to fill a part of the volume of the hollow body in such a way that an upper portion of the lateral wall of the hollow body is free and not involved with the product;
a step (e) of folding the upper portion of the lateral wall of the hollow body wherein the upper portion of the lateral wall is folded by pleating so as to form a pleated crown above the product contained in the hollow body;
a step (f) of applying and fixing the second circular piece above the pleated crown wherein the second circular piece is applied above the pleated crown and fixed to the pleated crown to form a closing cover and close the hollow body in such a way as to obtain a pod containing the product for preparation of a beverage;
a step (g) of unwinding and cutting the second film of biodegradable material from the second reel wherein the second film of biodegradable material is unwound from the second reel and is cut in such a way as to obtain a second sheet;
a step (h) of cutting the second sheet wherein the second sheet is cut in such a way as to obtain at least a third circular piece and at least a fourth circular piece, wherein the at least a third circular piece and the at least a fourth circular piece have a diameter substantially identical and of greater dimensions than the diameter of the pod;
a step (i) of heat-forming the third circular piece wherein the third circular piece heat-formed so as to form a first valve-shaped element having an annular peripheral portion and a first seat such as to be able to accommodate a lower part of the pod;
a step (I) of heat-forming of the fourth circular piece wherein the fourth circular piece is heat-formed so as to form a second valve-shaped element having an annular peripheral portion and a second seat such as to be able to accommodate an upper part of the pod;
a step (m) of inserting and positioning the pod in the first seat of the first valve-shaped element so that a lower part of the pod is accommodated in the first seat;
a step (n) of positioning the second valve-shaped element above the first valve-shaped element so that an upper part of the pod is accommodated in the second seat of the second valve-shaped element and so that the annular peripheral portion of the second valve-shaped element superposes on the annular peripheral portion of the first valve-shaped element;
a step (o) of fixing and sealing the first valve-shaped element to the second valve-shaped element wherein the first valve-shaped element and the second valve-shaped element are fixed to one another and sealed to one another at the relative annular peripheral portions (23, 33) superposed on one another in such a way as to seal the pod internally thereof and obtain a sealed biodegradable packaging of a product for preparation of a beverage.

2. The method of claim 1, wherein the step (c) of folding the first circular piece takes place by carrying out a drawing of the first circular piece by means of a punch shaped dosing element, wherein the punch shaped dosing element pushes the first circular piece through a circular through-hole so that the external circular portion of the first circular piece external of the circular through-hole is folded with respect to an internal circular portion of the first circular piece thus forming a hollow body having a circular base, defined by the internal circular portion, and a lateral wall defined by the external circular portion folded with respect to the internal circular portion, and wherein the step (d) of filling the hollow body with the product for preparation of a beverage is carried out during the lifting of the punch shaped dosing element from the hollow body, the punch shaped dosing element releasing and dosing the product for preparation of a beverage internally of the hollow body while being lifted and extracted from the hollow body.

3. The method of claim 1, wherein, during the step 30 of folding the first circular piece to form the hollow body, on the external circular portion of the first circular piece, folded with respect to the internal circular portion to form the lateral wall of the hollow body, fins are formed, externally projecting, and wherein, before the step (e) of folding the upper portion of the lateral wall of the hollow body which is folded by means of pleating to form a pleated crown above the product contained in the hollow body, a step (e1) of laterally folding the projecting fins is carried out so as to fold the fins against the lateral wall of the hollow body.

4. The method of claim 1, wherein, following the step (f) of applying and fixing the second circular piece above the pleated crown to form a closing cover and close the hollow body and to obtain a pod containing the product for preparation of a beverage, a step (f1) of compacting the pod and the product contained therein is carried out with elimination of air porosity by means of use of a sonotrode so as to obtain a compact pod ontaining the product for preparation of a beverage, the product being compacted and without air porosity.

5. The method of claim 1, wherein, during the step (f) of applying and fixing the second circular piece above the pleated crown a fixing of the second circular piece to the pleated crown is carried out by means of welding.

6. The method of claim 1, wherein the step (i) of heat-forming the third circular piece comprises heat-forming the third circular piece, by positioning it in a female heat-forming matrix and performing the heat-forming using a male heat-forming counter-matrix to push the third circular piece into the female heat-forming matrix and form the first valve-shaped element with the first seat in order to accommodate the lower part of the pod and wherein the step of heat-forming the fourth circular piece comprises heat-forming the fourth circular piece by positioning it at a male heat-forming matrix and 30 performing heat-forming using a female heat-forming counter-matrix so as to push the fourth circular piece about the male heat-forming matrix and form the second valve-shaped element with the second seat in order to accommodate the upper part of the pod.

7. The method of claim 1, wherein the step (o) of fixing and sealing the first valve-shaped element with the second valve-shaped element so as to seal the pod and obtain the packaging comprises:
a step (o1) of performing pre-welding spots between the annular peripheral portion of the first valve-shaped element and the annular peripheral portion of the second valve-shaped element, superposed on one another;
a step (o2) of aspirating the residual oxygen internally of the packaging and injecting an inert gas into the packaging inserting relative aspirating needles and injecting needles between the first valve-shaped element and the second valve-shaped element in the spaces present between the pre-welding spots;
a step (o3) of final welding which comprises carrying out a ring welding between the annular peripheral portion of the first valve-shaped element and the annular peripheral portion of the second valve-shaped element, superposed on one another, in order to seal the packaging.

8. The method of claim 7, wherein the step (o2) of aspirating the oxygen and injecting the inert gas is carried out by inserting the packaging in a controlled-atmosphere environment.

9. The method of claim 7, wherein the final welding step (o3) comprises further carrying out a supplementary welding, by completely welding together the annular peripheral portion of the first valve-shaped element and the annular peripheral portion of the second valve-shaped element, superposed on one another.

10. The method of claim 1, comprising providing a first reel of a first film of biodegradable material utilisable for formation of a pod for containing a product for preparation of beverages constituted by polylactic acid, and comprising providing a second reel of a second film of biodegradable material utilisable for formation of a cladding of the pod constituted by Ecoralene.

11. The method of claim 1, wherein the step (b) of cutting the first sheet of biodegradable material for obtaining at least the first circular piece and at least the second circular piece utilisable for realising the pod is carried out in such a way as to cut at least a first circular piece having a diameter comprised between 80 mm and 90 mm, and preferably 84 mm, and in such a way as to cut at least a second circular piece having a diameter comprised between 25 mm and 35 mm, and preferably 30 mm, and wherein the step (h) of cutting the second sheet of biodegradable material so as to obtain at least a third circular piece and at least a fourth circular piece utilisable for cladding the pod and for realising the packaging, is carried out in such a way as to cut at least a third circular piece and at least a fourth circular piece having a diameter comprised between 50 mm and 60 mm, and preferably 54 mm.

12. A biodegradable packaging of a product for preparation of a beverage, obtainable by means of the method of claim 1, comprising:
a pod made of a biodegradable material, containing a product for preparation of a beverage, a cladding made of a biodegradable material which envelops and seals the pod, wherein the pod comprises a hollow body, containing the product for preparation of a beverage, having a base wall and a lateral wall the upper portions of which are folded by means of pleating above the product to form a pleated crown, and a closing cover above the pleated crown and fixed to the pleated crown;
wherein the cladding comprises a first valve-shaped element having an annular peripheral portion and a first seat which receives a lower part of the pod and a second valve-shaped element having an annular peripheral portion and a second seat which receives an upper part of the pod, the first valve-shaped element and the second valve-shaped element being coupled to one another and sealed to one another at the relative annular peripheral portions.

13. The biodegradable packaging of claim 12, wherein the pod has a compacted shape without air porosity following a treatment utilising a sonotrode.

14. The biodegradable packaging claim 12, wherein the pod is made of a biodegradable material constituted by polylactic acid and wherein the first valve-shaped element and the second valve-shaped element which form the cladding are made of a biodegradable material constituted by Ecoralene.
